(19) United States
(12) Patent Application Publication
(10) Pub. No.: US 2009/0132792 A1
(43) Pub. Date: May 21, 2009

(54) Method of generating internode timing diagrams for a multiprocessor array

(76) Inventor: Dennis Arthur Ruffer, Castle Rock, CO (US)

Correspondence Address: HENNEMAN & ASSOCIATES, PLC, 714 W. MICHIGAN AVE., THREE RIVERS, MI, 49093, US

(21) Appl. No.: 11/985,566

(22) Filed: Nov. 15, 2007

(51) Int. Cl. G06F 9/30

(52) U.S. Cl. 712/220; 712/E09.016

(57) ABSTRACT

The apparatus used includes a multi core computer processor 10 where a plurality of processors 15 is located on a single substrate 25. Processors 15 are connected to their nearest neighbor directly by single drop data busses 20. The method is executed by an application code that includes functions which determine the internode timing. These functions are performed as the code executes. The code performs these functions by utilizing manually specified real time for clock cycles. In addition, captured data from an event driven simulator presents accurate clock cycle count information for the hardware. The code generates timing diagrams using this data. The timing diagrams can be used to compare and analyze the code behavior as it executes in the target multiprocessor array hardware. This method allows determination of how the actual hardware events correlate to the expected events that were simulated for a given instruction sequence.

### FIELD OF INVENTION

The present invention relates to the field of computers and computer processors, and more particularly to a method of analyzing data communication timing between combinations of multiple computers on a single microchip. With still greater particularity, analysis of operating efficiency is important because of the desire for increased operating speed.

### DESCRIPTION OF THE BACKGROUND ART

It is useful in many information processing applications to use multiple computers (also referred to as nodes) to speed up operations. Dividing a task and performing multiple computing operations in parallel at the same time is known as parallel computing. There are several systems and structures used to accomplish this. Application developers for multiple computing operations in parallel utilize sophisticated methodologies to assure that instruction execution timing operates as expected.

For example, one method uses a system simulator to predict when events will occur in the actual hardware. The application is first run in the simulator and the event times are recorded. Next, the exact same application is run on the target hardware, and the recorded simulator event times are correlated with the bench measurements for those event times.

Timing diagrams are often documented as part of a design specification, which is then used as a guideline to meet the internode communication timing requirements, while developing the multiprocessor program code. A problem with this approach is that the actual hardware timing is unknown. As a result, the application developer must use trial and error techniques to close in on the actual hardware timing that will execute the code correctly. This is a very time consuming and consequently expensive process for debugging.

### BRIEF DESCRIPTION OF THE DRAWINGS

FIG. 1 is a block diagram view of a computer array used in an embodiment of the invention;

FIG. 2 is a timing diagram for one embodiment of the invention.

### DESCRIPTION OF THE INVENTION

The method is executed by an application code that includes functions which determine the internode timing. These functions are performed as the code executes. The code performs these functions by utilizing manually specified real time for clock cycles. In addition, captured data from an event driven simulator presents accurate clock cycle count information for the hardware. The code generates timing diagrams using this data. The timing diagrams can be used to compare and analyze the code behavior as it executes in the target multiprocessor array hardware. This method allows determination of how the actual hardware events correlate to the expected events that were simulated for a given instruction sequence.

### DETAILED DESCRIPTION OF THE DRAWINGS

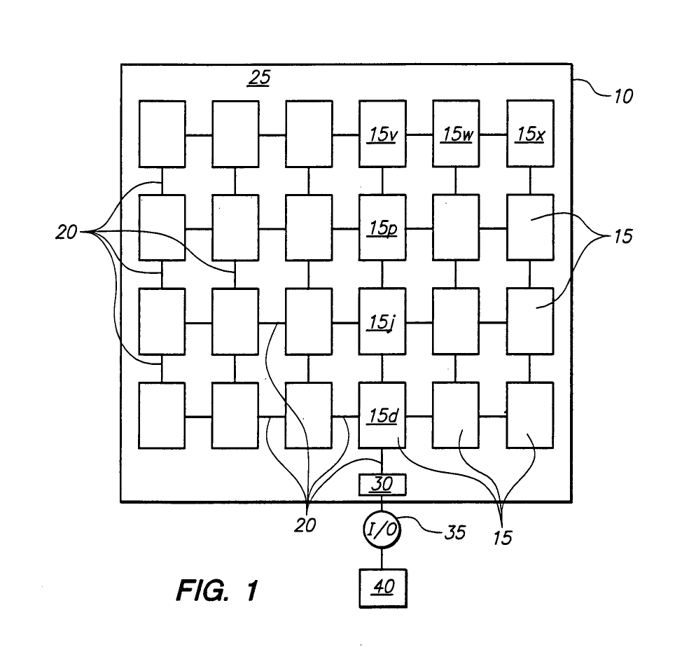

The multiple core processor array (computer array) used in the method of the invention is depicted in a diagrammatic view in FIG. 1 and is designated therein by the general reference character 10. The computer array 10 has a plurality (twenty-four in the example shown) of computers 15 (sometimes referred to as “processors”, “cores” or “nodes”). In the example shown, all the computers 15 are located on a single die (also referred to as “chip”) 25. Each of the computers 15 is a general purpose, independently functioning computer and is directly connected to its physically closest neighboring computer by a plurality of single drop data and control buses 20. In addition, each of the computers 15 has its own local memories (for example, ROM and RAM) which hold substantially the major part of its program instructions, including the operating system. Nodes at the periphery of the array (in the example shown, node 15d), can be directly connected to chip I/O ports 30. External input-output (I/O) connections 35 to the chip I/O ports 30 are for the general purpose of communicating with external devices 40. An example of a multiple computer array described above is the SEAforth™ C18 twenty-four node single chip array made by IntellaSys™.

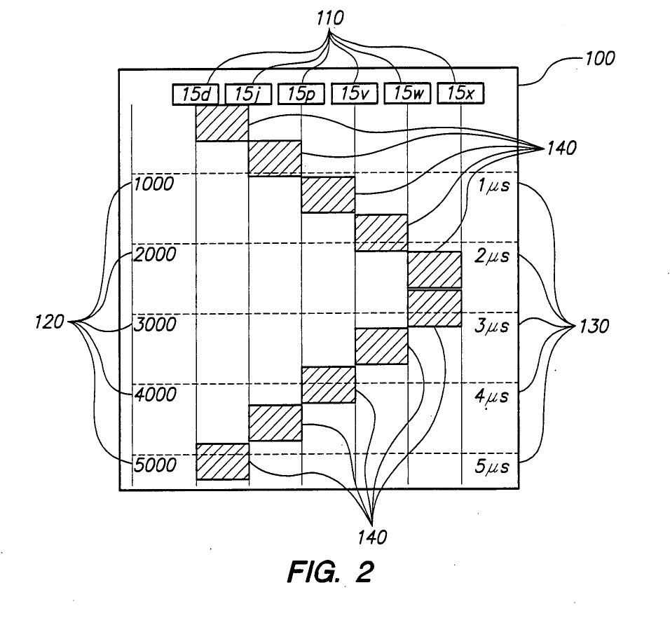

FIG. 2 illustrates one example of a Timing Diagram according to the invention, designated therein by the general reference character 100. In the example shown, with reference to FIG. 1, the node numbers 110 identify the specific nodes 15 which are utilized to generate the diagram 100. The column of numbers 120 on the left side of the diagram represent simulator clock cycles. The column of numbers 130 on the right side of the diagram represents real time values in units of microseconds.

The staggered hatched blocks (also referred to as “time blocks”) 140 in the middle of the diagram are plotted from event data captured by the program code as it executes instructions. For this application, the initial program code is received by node 15d (from external device 40 through I/O ports 30) then program execution is started. The program copies itself to node 15j, which is represented in elapsed time by the upper left time block. When node 15d completes the copy process, it goes into a sleep mode, and node 15j begins copying itself to node 15p. When node 15j completes the copy process, it goes into a sleep mode, and node 15p begins copying itself to node 15v. This sequence continues, as depicted by the diagram, until node 15w has completed its copying process to node 15x, which subsequently begins copying its program back to node 15w. This reverse copying sequence continues until the program code is copied to node 15d, which completes the process flow. The engineer then uses this completed timing diagram 100 to determine if the actual hardware events for the given instruction sequence correlate to the expected events that were simulated.

Another aspect of the invention is that actual hardware timing can be correlated to the simulator clock cycle. For this embodiment, the SEAforth™ T18 simulator is used, which is a unit delay simulator, as known in the art. In particular, a unit delay simulator does not associate real time units (such as nanoseconds) to instruction clock cycles. Instead, all events are associated with a specific number of clock cycles. This inventive method includes a manual step which allows an engineer to specify how much time a clock cycle takes, prior to executing the program code. The resulting Timing Diagram then includes real time values 130 on the right side of the diagram 100 that correspond to the simulator clock cycles 120 on the right side of the diagram 100. In the example shown in FIG. 2, clock cycle timing data was specified by design to be 1 nanosecond per clock cycle. Hence, in the diagram 100, 1000 clock cycles 120 is equivalent to 1 microsecond (1000×1 nanosecond) of real time 130. In other embodiments, an engineer captured timing data from the actual hardware, to calibrate by empirical methods how much time equates to a simulator clock cycle.

This method has the advantage of reducing debug time, because it allows a developer to have visibilty of the actual timing internal to the chip; this timing is otherwise not accessible. Another application of the method is to use the technique of placing “dummy” code in nodes while doing design and analysis to see timing in advance, as a part of the design step. This allows the use of the simulator/chip combination to produce documentation, rather than hand drawing these sorts of diagrams. The hand drawing of timing diagrams is a time and money consuming portion of the current state of the art.

In particular, this method is extremely advantagious for analyzing asynchrounous computer systems (such as the SEAforth™ C18), as opposed to sychronous computer systems known in the art. The latter systems contain a hardware clock cycle that correlates directly to the simulator clock cycle. Whereas, the former system does not contain a clock in the hardware, making it much more difficult for the programmer to use trial and error techniques to close in on the actual hardware timing, which is a very time consuming process for debugging. The present inventive method solves that problem.

The method is not limited to implementation on one multiple core processor array chip, and with appropriate circuit and software changes, it may be extended to utilize, for example, a multiplicity of processor arrays. It is expected that there will be a great many applications for this method which have not yet been envisioned. Indeed, it is one of the advantages of the present invention that the inventive method may be adapted to a great variety of uses.

Those skilled in the art will readily observe that numerous other modifications and alterations may be made without departing from the spirit and scope of the invention. Accordingly, the disclosure herein is not intended as limiting and the appended claims are to be interpreted as encompassing the entire scope of the invention.

### INDUSTRIAL APPLICABILITY

The inventive computer logic array 10 instruction set and method are intended to be widely used in a great variety of computer applications. It is expected that they will be particularly useful in applications where significant computing power and speed is required.

As discussed previously herein, the applicability of the present invention is such that the inputting information and instructions are greatly enhanced, both in speed and versatility. Also, communications between a computer array and other devices are enhanced according to the described method and means. Since the inventive computer logic array 1, and method of the present invention may be readily produced and integrated with existing tasks, input/output devices and the like, and since the advantages as described herein are provided, it is expected that they will be readily accepted in the industry. For these and other reasons, it is expected that the utility and industrial applicability of the invention will be both significant in scope and long-lasting in duration.

I claim:

1. A method of generating internode timing diagrams for computer systems having a plurality of processors; each processor having local memory and connected directly to at least two adjacent processors comprising the steps of introducing an instruction to a processor on the periphery of the computer system, loading the instruction into local memory, copying said instruction into an adjacent processor, repeating the process for each processor in said computing system, noting the time required for each loading step and using the collection of loading times noted to generate a timing diagram.

2. A method of generating internode timing diagrams for computer systems as in claim 1, wherein empirical timing data from target hardware is used to calibrate simulator clock cycle timing.

3. A method of generating internode timing diagrams for computer systems as in claim 1, wherein design specification timing data defines simulator clock cycle timing.

4. A method of generating internode timing diagrams for computer systems as in claim 1, wherein said computer system is an asynchronous computer systems.

5. A method of generating internode timing diagrams for computer systems as in claim 1, wherein said method further provides internal chip timing data.

6. A method of generating internode timing diagrams for computer systems as in claim 1, wherein said method further automatically provides empirical data to be used in device documentation.

7. A method of generating internode timing diagrams for computer systems as in claim 1, wherein the resulting timing diagram includes real time values that correspond to simulator clock cycles.

8. A system for generating internode timing diagrams for computer systems comprising: a chip having a plurality of processors each processor having local memory and connected directly to at least two adjacent processors and indirectly to all processors on said chip, and a first set of software instructions to travel from one chip to another and report the time required for such travel to each chip, and further software instruction for converting the time reported by said first set into an internode timing diagram.

9. A system for generating internode timing diagrams for computer systems as in claim 8, wherein said processors are asynchronous processors.

10. A system for generating internode timing diagrams for computer systems as in claim 9, wherein said processors are laid out in a rectangular grid with at least one processor on the periphery of said grid is dedicated for interfacing with the outside environment.

11. A system for generating internode timing diagrams for computer systems as in claim 10, wherein said one processor is the entry point for said instruction set.

12. A system for generating internode timing diagrams for computer systems as in claim 11, wherein said instruction set visits each processor on said chip.

13. A system for generating internode timing diagrams for computer systems as in claim 11, wherein the resulting timing diagram includes real time values that correspond to simulator clock cycles.

14. A set of instructions for use in a multi core processor wherein each core includes local memory and is directly connected to at least two other cores for generating an internode timing diagram comprising: an instruction for loading said set of instructions into said local memory of the first processor encountered; an instruction for recording the amount of time required to load said set of instructions into local memory; an instruction to transmit said set of instructions to an adjacent core's local memory; a second instruction to record the time required to load said set of instructions into said adjacent core; an instruction to collect all times recorded; and an instruction for converting all times collected into a timing diagram.

15. A set of instructions for use in a multi core processor as in claim 14, wherein there is an instruction to load said set of instructions into each core, and an instruction to record the time required to load into each core of said processor.

16. A set of instructions for use in a multi core processor as in claim 15, wherein there are at least 24 load instructions.

17. A set of instructions for use in a multi core processor as in claim 15, wherein one of said instructions contains an instruction to load itself into a processor on the periphery of a multi core processor having at least 24 cores.

18. A set of instructions for use in a multi core processor as in claim 15, wherein there are at least 40 load instructions.
